(19) United States
(12) Patent Application Publication
(10) Pub. No.: US 2007/0002692 A1
(43) Pub. Date: Jan. 4, 2007

(54) Programmable mask for waking an individual

(76) Inventor: David L. Van Brunt, Danville, IN (US)

Correspondence Address: BARNES & THORNBURG LLP, 11 SOUTH MERIDIAN, INDIANAPOLIS, IN, 46204, US

(21) Appl. No.: 11/170,361

(22) Filed: Jun. 29, 2005

(51) Int. Cl. G04B 19/00

(52) U.S. Cl. 368/79

(57) ABSTRACT

In one embodiment, a mask-like apparatus worn by a user includes a programmable controller for controlling the illumination of a light source such as one or more light emitting diodes (LEDs) which are positioned to illuminate the eye area of the user. The programmable controller is battery powered such that the mask is portable. Illumination intensity profiles are used by the controller to control the level of intensity of the illumination to create a time-phased increase in intensity so as to wake the user.

### BACKGROUND

The present invention relates to devices used to wake individuals by gradually intensifying light directed to the eyes of the individual. More specifically, the present invention is directed to a mask-like device which is programmable to selectively intensify light directed to the eyes of an individual.

One neural mechanism for human arousal after sleep is through the stimulation of a neural pathway in the brain referred to as the “retinohypothalamic pathway”, which sends signals from the retina to another brain structure called the suprachiasmatic nucleus (SCN). The SCN is generally regarded as a key circadian pacemaker (i.e, “biological clock”). The connection to the optic nerves is no coincidence; the nucleus is stimulated by an increase in light entering the eyes, (such as happens at sunrise), making the sharp increase in light following the dark of night a natural stimulus for awakening. Most modem alarm clocks, however, do not entrain users to awaken in this natural manner. Instead, they use the auditory pathways to literally “alarm” the user into wakefulness, which is a more abrupt means of awakening that many may find aversive, or initially ineffective (many alarms have a “snooze” function so that users who have not become fully aroused can gain a few minutes more sleep).

In recent years, other inventors have leveraged the use of timed illumination to serve as an alternative to audio alarms for awakening. These devices illuminate the entire room in which they operate, thereby subjecting any other room occupants (e.g., a spouse) to the stimulus and affecting their sleep schedule. This approach is shared with standard audio alarm clocks, which may interrupt the sleep of persons other than the intended beneficiary. Also, the effect of illumination is diminished in environments which already have a high level of ambient light, as the added neural stimulation above background must be greater in order be noticed in such ‘noisy’ environments (due to sensory adaptation). In other words, turning on a light during a daytime nap is not as likely to arouse a person as turning as turning on a light in the middle of a dark night.

### SUMMARY

The present disclosure comprises one or more of the features recited in the appended claims and/or the following features which, alone or in any combination, may comprise patentable subject matter:

In one embodiment, present invention is a programmable apparatus for waking an individual by directing light onto the eye area of the individual while the individual is sleeping. In another embodiment, the apparatus includes a mask portion, at least one light source coupled to the mask portion, a controller coupled to the at least one light source and configured to vary the intensity of the light source. In use, the mask blocks ambient light from impinging on the eye area of the individual. Light which impinges on the closed eyelids of an individual is known to stimulate the optic nerves. The mask is configured to block ambient light during times of sleep whether the individual's eyes are closed or open.

At a predetermined time, the controller may begin to power at least one light source to provide a controlled intensity of light energy to impinge upon the eye area of the individual to begin stimulation of the optic nerves. The controller may be programmed to provide a gradually increasing intensity of light, a stepwise increase in the intensity of light, cyclical changes in the intensity of light, or any of a number of other variations to the intensity of light as programmed by a user.

The controller may include a microprocessor, a memory device, multiple user input devices, and a display. The controller may be configured so as to allow a user to program the beginning time of a light intensity cycle, and intensity variation profile, and a light intensity cycle termination time. The controller may be configured such that the memory device is operable to store multiple intensity profiles which may be selected by a user to be activated at a predetermined time. The controller may also include a real-time clock electrical communication with the microprocessor. The controller may be coupled directly to the mask or, in some embodiments, the controller may be in electrical communication with the mask that located elsewhere. In some embodiments, the microprocessor may be omitted and replaced with any of a number of different logic devices which are capable of receiving user input's and executing commands.

The mask may be configured to conform to the facial features of an individual to assist preventing ambient light from impinging on the eye areas of the individual. In some embodiments, the mask may be fabric. In other embodiments, the mask may be molded to form a cavity between the mask and the eye area of the individual with a viscoelastic material around the edges of the mask to accommodate a form fit to the face of the individual.

Additional features, which alone or in combination with any other feature(s), including those listed above and those listed in the claims, may comprise patentable subject matter and will become apparent to those skilled in the art upon consideration of the following detailed description of illustrative embodiments exemplifying the best mode of carrying out the invention as presently perceived.

### BRIEF DESCRIPTION OF THE DRAWINGS

The detailed description particularly refers to the accompanying figures in which:

FIG. 1 is a perspective view of one embodiment of a programmable mask for waking an individual;

FIG. 2 is a block diagram of an electrical system of the programmable mask of FIG. 1;

FIG. 3 is a back view of a mask portion of the programmable mask embodiment of FIG. 1 with an array of the LEDs positioned on the mask such that the LEDs would direct light onto the eye areas of a person wearing the mask;

FIG. 4 is a back view of another embodiment of a mask portion of the programmable mask of FIG. 1 with an array of the LEDs positioned on the mask such that the LEDs would direct light onto the eye areas of a person wearing the mask;

FIG. 5 is an enlarged view of a user interface of the programmable mask of FIG. 1;

FIG. 6 is a diagrammatic view of a light intensity profile wherein the light intensity increases linearly over time; and

FIG. 7 is a diagrammatic view of a light intensity profile wherein the light intensity increases exponentially over time.

### DETAILED DESCRIPTION

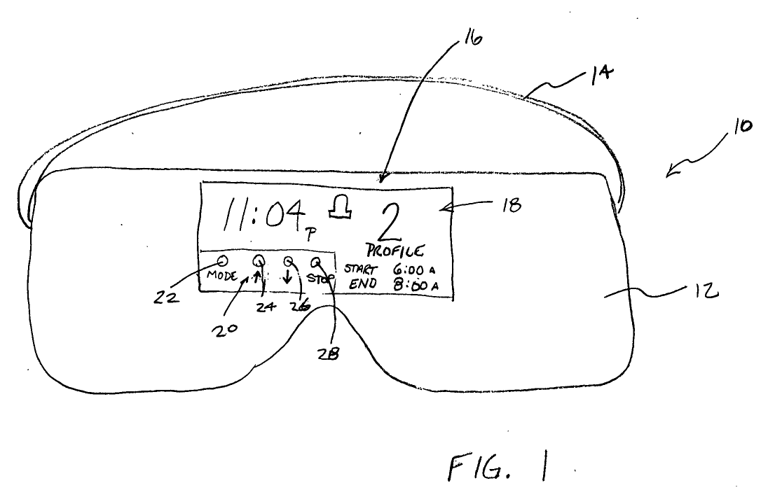

The present invention is a programmable mask apparatus 10, shown in FIG. 1, which is configured to be worn by an individual during times of sleep and is programmable to wake the individual by directing light onto the eye areas of the individual. The programmable mask apparatus 10 includes a mask portion 12, a retainer 14, and a controller 16. Controller 16 includes a display portion 18 and a user input portion 20. A user programs the programmable mask apparatus 10 by activating various user inputs 22, 24, 26, and 28. Various pieces of information are displayed on the display portion 18 to provide the user feedback during programming of the programmable mask apparatus 10, as will be discussed in further detail below.

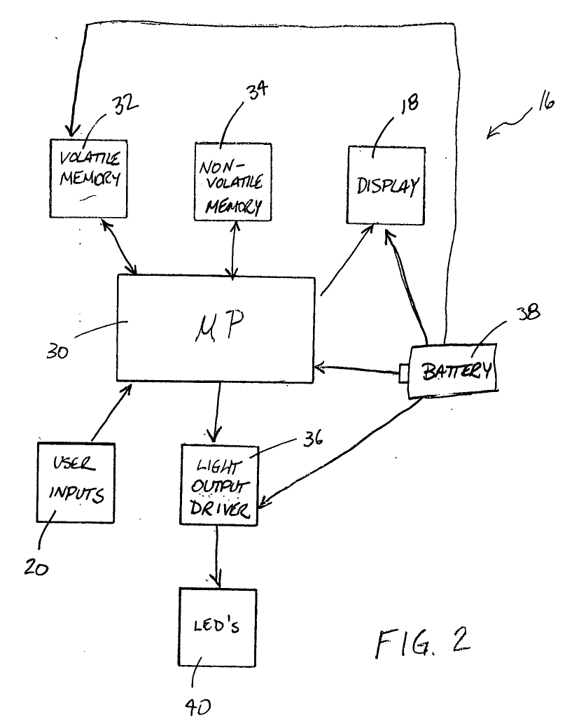

Referring now to FIG. 2, controller 16 includes a microprocessor 30, volatile memory 32, nonvolatile memory 34, user inputs 20, display 18, and light output driver circuitry 36. A battery 38 powers both the microprocessor 30 and LEDs 40 which are located on the mask portion 12 (see FIG. 1). Microprocessor 30 is in communication with both volatile memory 32 and nonvolatile memory 34 and stores various operating parameters of the programmable mask apparatus 10 which are then used by the microprocessor 32 control operation of the programmable mask apparatus 10 as programmed by a user.

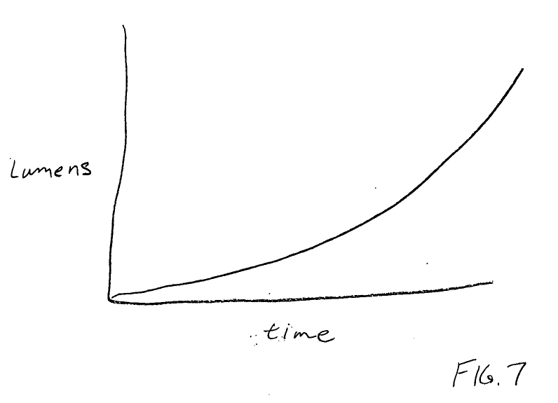

Programmable mask apparatus 10 is configured to be programmed by a user to develop a light intensity profile and to execute the light intensity profile at a time predetermined by the user. The light intensity profile may be any of a number of profiles which are used to wake the individual from sleep. For example, one profile, as shown in FIG. 6, linearly increases the intensity of light emitted by the LEDs over time to gradually rouse the individual. In yet another profile, shown in FIG. 7, the intensity of the light emitted by the LEDs increases exponentially over time. It should be understood that due to the nature of the programmable microprocessor, any of a number of profiles may be programmed by a user so that an intensity profile specific to the needs of the user may be programmed. For example, stepwise increases, logarithmic increases, sinusoidally increasing, or any of a number of other profiles may be employed based on the needs of the user.

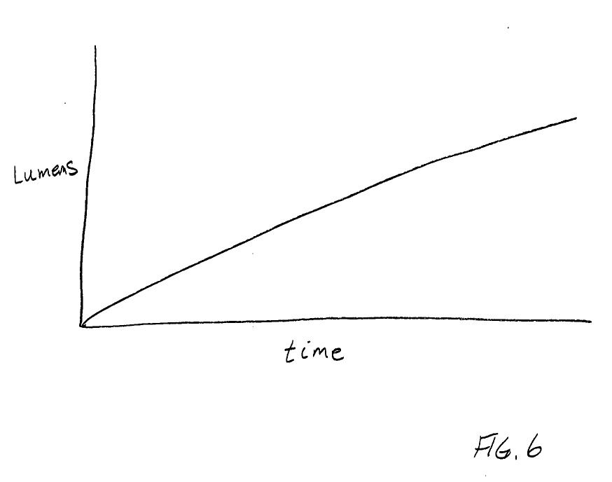

In the illustrative embodiment of FIG. 1, user input portion 20 includes four user input devices 22, 24, 26, 28. User input devices 22, 24, 26, 28 of the illustrative embodiment are buttons which may be activated by a user to perform programming steps. Input device 22 operates as a mode select key which provides the user the ability to step through various portions of display 18. Referring now to FIG. 5, display 18 is shown with various sections separated by dotted lines. Display 18 is a liquid crystal display (LCD) providing a number of rows and a number of columns of pixels which are utilized to form a display output. In some embodiments, the LCD display may be omitted and display 18 may comprise a number of liquid crystal segments which are illuminated to form output on display 18. For example, some of the liquid crystal segments may be formed in the shape of icons to convey information.

As shown in FIG. 5, a clock display 42 includes an hours portion 44 and a minutes portion 46. Clock portion 42 displays time in a 12 hour basis and so therefore includes an AM/PM indicator 48. To program the time on clock portion 42 a user activates the mode user input 22 to activate the hours portion 44 of clock display 42. The user then increments powers portion 44 utilizing increasing user input 24 or decreasing user input 26 as necessary to select the appropriate hour in hour portion 44. The user then activates mode user input 22 again to deactivate hour portion 44 while simultaneously activating minute portion 46. Again, the user utilizes increasing input 24 or decreasing input 26 to select the appropriate minute value. Once the appropriate minute value has been selected a user then activates mode user input 22 again to deactivate minute portion 46 while simultaneously activating AM/PM indicator 48. Activating the increasing user input 24 or decreasing user input 26 to select the appropriate indication of AM or PM, the user can finalize the setting of clock portion 42. It should be understood that in the illustrative embodiment of FIG. 5, AM/PM indicator 48 is a single alphanumeric character and the character “a” would be chosen for AM and the character “p” would be chosen to indicate PM. In some embodiments, the clock portion 42 may display time in a military (i.e. 24 hour) format. In those embodiments, the AM/PM indicator 48 would be omitted.

After setting the clock portion 42, a user cycles to alarm active indicator 50 by activating mode user input 22. Alarm active indicator 50 is an iconic indicator in the shape of a bell to indicate that an alarm condition has been set. When the alarm condition is set, the alarm active indicator 50 is illuminated to show the bell icon. If there is no alarm condition set, the bell icon does not appear in the alarm active indicator 50 area.

When the alarm is active, a profile indicator 52 will indicate which of multiple profiles has been selected. In the illustrative embodiment described herein, the programmable mask apparatus 10 is programmed with multiple predetermined intensity profiles which may be selected by a user. The user selects the appropriate profile from a cross-reference document such as a user manual which accompanies the device. If the alarm active indicator 50 is set to active, a user then activates the mode select user input device 22 to toggle to the profile indicator 52 portion of the display 18. The user then uses the increasing user input 24 or decreasing user input 26 to select the appropriate profile by altering the numerical display in profile indicator 52. Profile indicator 52 displays a two digit indicator of the profile selected on profile indicator 52. In other embodiments, the user may program a profile from a predetermined set of parameters such as beginning intensity, ending intensity, length of profile in time and profile shape.

Once a profile has been selected or programmed, the user activates the mode select input device to toggle to a start time portion 54 where the user sets the appropriate start time for the profile selected in profile indicator 52 in a manner similar to the setting of clock portion 42. Once the start time has been selected, the user activates the mode select input device 22 to toggle to an end time portion 56 of display 18 to set an appropriate end time for the profile selected. This permits the user to pre-program a termination of the profile selected. While it is contemplated that in most circumstances the user will affirmatively stop the profile by depressing a stop user input device 28, the preprogramming of an end time assures that the mask will not run continuously if it is mistakenly removed without stopping the profile. If the time selected is 0:00, then the preprogrammed end time feature is deactivated.

Referring again to FIG. 2, the information regarding start time, end time, and alarm status is stored in volatile memory 32 which is a flash memory device in the illustrative embodiment. Battery 38 provides power to volatile memory 32 to support maintenance of the information in volatile memory 32. The various profiles are stored in nonvolatile memory 34. Microprocessor 30 utilizes the information stored in memory to control the operation of light output driver circuitry 36 which then controls LEDs 40. Light output driver circuitry 36 receives power from battery 38 and selectively powers LEDs 40 based on control signals from microprocessor 30. In the illustrative embodiment, light output driver circuitry 36 selectively powers LEDs in an array to control the intensity of light directed onto the eye areas of the individual.

Referring now to FIG. 3, a user facing side 58 of mask 12 shows two arrays 60, 62 of LEDs 40 positioned such that illumination of the LEDs 40 would result in the illumination of an eye area of an individual wearing mask 12. Array 60 and array 62 are substantially similar in configuration and location relative to the eye area of a user. Described herein is the operation of a single array 60, however, it should be understood that the description of array 60 is applicable to the operation of array 62 as well. The LEDs 40 are oriented such that a center LED 40 is surrounded by two concentric circles of LEDs 40. In the illustrative embodiment of FIG. 3, the intensity of light disposed on the eye area of a user is increased by selectively and sequentially activating the LEDs 40 so that additional illumination is provided with the activation of additional LEDs 40. For, example, the center LED 40 may be illuminated first, the first concentric circle of LEDs 40 illuminated subsequently, and the final concentric circle of LEDs 40 illuminated. By controlling number of LEDs illuminated, the intensity of light distributed on the eye area of a user is controlled. It should be understood that a larger array may be used to provide greater intensity of emitted light.

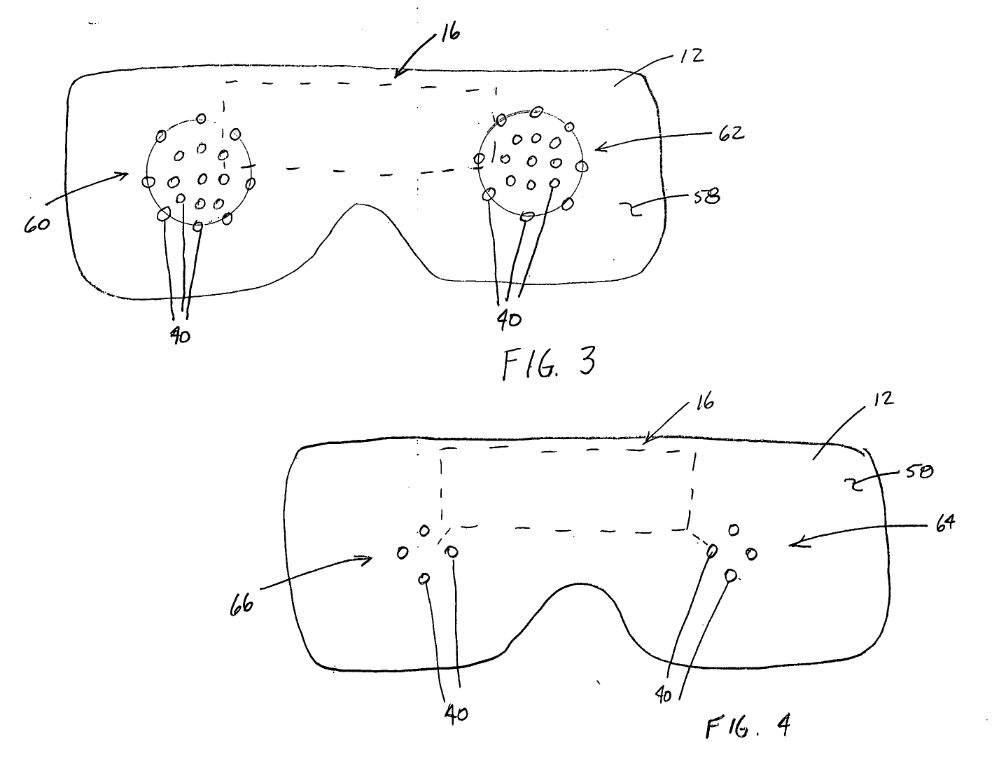

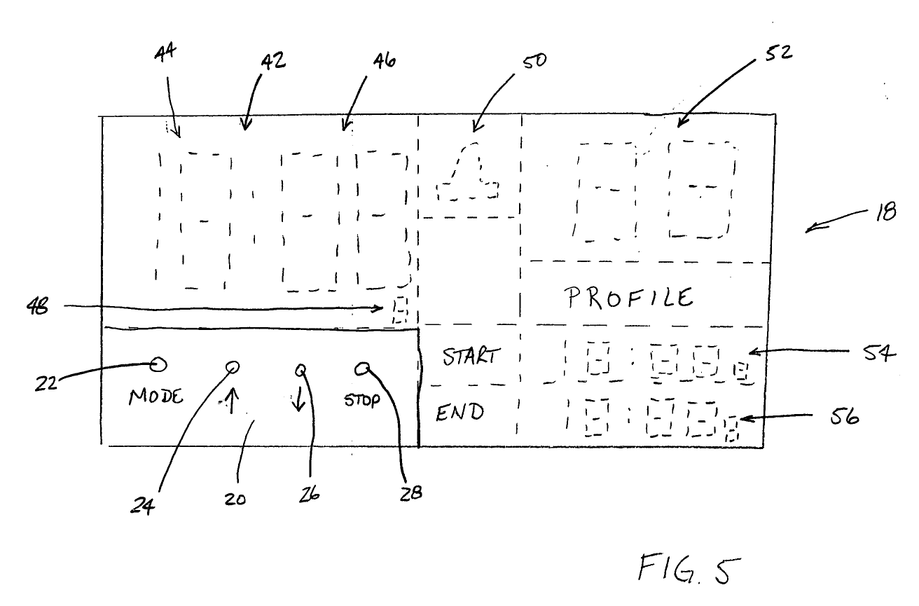

In another embodiment, control of intensity of illumination of the eye area of a user may be controlled by controlling the current passing through the LEDs. Variation in current varies the intensity of the output of the LED. In the illustrative embodiment of FIG. 4, four LEDs 40 are positioned in each of two arrays 64, 66. In this configuration, the current through the LEDs 40 in each array 64, 66 is controlled by the light output driver circuitry 36 (seen in FIG. 2) by controlling the value of resistance in series with the LEDs as is well known in the art. The control of illumination of the light area is therefore controlled by controlling the intensity of the LEDs 40 in the arrays 64, 66.

While the illustrative embodiments of FIGS. 3 and 4 discuss two approaches to controlling light intensity, it should be understood that any of a number of techniques for controlling illumination of LEDs specifically and light sources generally are known in the art. Combinations of these methods of controlling LEDs may be employed to control the intensity of illumination of the eye area of a user. In some embodiments, LEDs 40 may be omitted and another source of illumination may be substituted. For example, light bulbs, fiber optic cable, or any selectively illuminable device. Also, in some embodiments, the mask may further comprise a diffuser position

The mask 12 is constructed of a flexible fabric material which allows the mask to conform to facial features of the user which thereby blocks ambient light. The mask includes an opaque material to assist in the blocking of ambient light. In some embodiments, the mask may take the form of a goggles shaped to closely match the shape of a users face to prevent ambient light. In some embodiments, the goggles may further comprise a viscoelastic foam coupled to the goggles to contact the face of the individual and provide a form fit between the goggles and the face of the individual.

Although certain illustrative embodiments have been described in detail above, variations and modifications exist within the scope and spirit of this disclosure as described and as defined in the following claims.

1. An apparatus for waking an individual having a face and an eye area comprising:
a mask,
a retainer coupled to the mask configured to retain the mask on the face of the individual,
a light source coupled to the mask and positioned to direct light on the eye area of the individual, and
a controller attached to the mask, the controller including user inputs and a display,
wherein the controller is configured to be pre-set to control operation of the light source to vary the intensity of the light.

2. The apparatus of claim 1, wherein the light source includes a light emitting diode.

3. The apparatus of claim 1, wherein the mask is opaque.

4. The apparatus of claim 3, wherein the mask substantially blocks ambient light from impinging on the eye area of the individual.

5. The apparatus of claim 1, wherein the mask includes a fabric.

6. The apparatus of claim 1, wherein the mask conforms to the facial features of the individual so as to prevent ambient light from impinging on the eye areas of the individual.

7. The apparatus of claim 1 wherein the controller is programmable to activate the light source at a predetermined time.

8. The apparatus of claim 7 wherein the controller is programmable to increase the intensity of the light source over time.

9. The apparatus of claim 8 wherein the controller includes memory to store multiple intensity profiles to be selected by a user to be activated at a predetermined time.

10. The apparatus of claim 1 wherein the controller comprises a microprocessor.

11. A mask for waking an individual having eyes, the mask comprising
an opaque portion having a first side and a second side, the opaque portion blocking ambient light from impinging on the eyes of the individual,
a luminiferous portion positioned on the first side of the opaque portion to illuminate the eyes of the individual, and
a battery-powered controller attached to the mask, the controller including a microprocessor, memory, user inputs and a display,
wherein the controller is configured to be programmed to control operation of the luminiferous portion to vary an intensity of illumination to wake the individual from a sleeping state.

12. The apparatus of claim 11, wherein the luminiferous portion includes at least one light emitting diode.

13. The apparatus of claim 11, wherein the opaque portion is fabric.

14. The apparatus of claim 11, wherein the controller is programmable to activate the luminiferous portion at a predetermined time.

15. The apparatus of claim 14 wherein the controller is programmable to end the illumination at a predetermined time.

16. The apparatus of claim 11, wherein the display includes a time display portion, an alarm status indicator, a profile status indicator, and a profile start time indicator.

17. The apparatus of claim 11, wherein the controller includes a number of preprogrammed illumination intensity profiles stored in memory and selectable by a user to wake the individual.

18. An alarm device for waking an individual having eyes comprising:
an opaque portion blocking substantially all ambient light from the eyes of the individual,
at least one light source attached to the opaque portion and positioned to direct light on the eye area of the individual, and
a microprocessor in communication with the light source,
a memory device in communication with the microprocessor,
a display including a clock portion, an alarm status portion, and an alarm adjustment portion, the display attached to the opaque portion and in communication with microprocessor,
user inputs coupled to the display, and
a battery,
wherein the device is configured to be programmed to control operation of the light source to vary the intensity of the light to wake the individual from a sleeping state.

19. The device of claim 18, wherein the device further includes a plurality of preprogrammed light intensity profiles which may be selected from the memory to control timing and operation of the light source.

20. The device of claim 19, wherein the display further includes an indicator of the light intensity profile selected.
